(19) United States
(12) Patent Application Publication
(10) Pub. No.: US 2006/0062259 A1
(43) Pub. Date: Mar. 23, 2006

(54) Optical wavelength control system and related method of assembly

(76) Inventors: Franco Delpiano, Collegno (IT); Victor Bogdan Guja, San Giusto Canavesa (IT)

Correspondence Address: PERMAN & GREEN, 425 POST ROAD, FAIRFIELD, CT, 06824, US

(21) Appl. No.: 11/222,891

(22) Filed: Sep. 9, 2005

(30) Foreign Application Priority Data
Sep. 21, 2004 (GB) 0420899.7

(51) Int. Cl. H01S 3/10

(52) U.S. Cl. 372/9

(57) ABSTRACT

An optical wavelength control system for an optical source, includes: a beam splitter arrangement for propagating radiation from the source over two paths, first and second photodetectors, each arranged at a respective one of the two propagation paths, a wavelength selective optical filter affecting propagation of said radiation over the propagation path to the first photodetector, whereby the first and second photodetectors are adapted to generate photocurrents indicative of the possible displacement of the actual wavelength of the radiation from the source with respect to a reference wavelength and the power emitted by the optical source, respectively. The wavelength selective optical filter is e.g. an interference filter or an etalon filter arranged to receive reflected radiation from the beam splitter arrangement.

The present invention relates to optical wavelength control systems and was devised in view of the possible use in optical communication systems.

The invention was developed by paying specific attention to so-called wavelength locking arrangements for use in optical transmitter sub-assemblies (TOSAs) for optical communication systems. Exemplary of such systems are wavelength division multiplex (WDM) communication systems.

However, reference to this preferred field of use must in no way be construed as limiting the scope of the invention.

Commercial WDM (Wavelength Division Multiplex) transmission systems, such as “dense” WDM (DWDM) systems provide high transmission capacity by using reduced channel spacing (e.g. 100-50 GHz). Real time monitoring and control of the wavelength is necessary in order to ensure-channel peak wavelength stability of the optical sources used in such systems.

A number of devices adapted for that purpose (and primarily for wavelength monitoring) are based on the arrangement currently referred to as “wavelength locker”. This usually consists of two photodiodes that sample two portions of the optical beam (typically a laser beam). A portion of the laser beam is passed through an optical filter and caused to impinge onto the first photodiode. The second photodiode, used as a reference, samples an unfiltered portion of the laser beam. The response (i.e. the photocurrent) of the first diode is thus a function of the possible displacement of the actual wavelength of the beam generated by the laser source with respect to the wavelength of the filter. The response of the second diode is indicative of the power emitted by the optical source.

A beam splitter arrangement is used to split the laser beam into a main beam to be used for the intended application (e.g. for launching into a fiber) and one or more secondary beam or beams to be directed towards the photodiodes of the locker arrangement.

Various arrangements are known in order to effect stabilisation. For instance, in the case of diode lasers, a Peltier cell can be used as a wavelength stabilising element by controlling the temperature of the laser diode while power stabilisation is implemented by controlling the laser bias current.

Arrangements of the general type referred to in the foregoing, or substantially similar thereto, are disclosed e.g. in U.S. Pat. No. 5,825,792 and U.S. Pat. No. 6,094,446.

Specifically, the arrangement of U.S. Pat. No. 5,825,792 comprises a narrow band-pass, wavelength selective transmission filter element, of Fabry-Perot etalon structure, through which a non-collimated beam from a laser source is directed onto two closely spaced photodetectors. For wavelength stabilisation, the differential output of the two photodetectors is used in a feedback loop to stabilise the wavelength of the laser source to a desired target wavelength. Through the angular dependence of wavelength transmission of the Fabry-Perot etalon, the wavelength variation from the source is converted to a transmission loss, which is different for the two photodetectors, so that the wavelength change is detected as a differential power change. The device functions as an optical wavelength discriminator in which the detectors convert optical energy to current for a feedback loop for controlling the light source. A lens may be used to control the divergence of the light incident on the filter element to optimise power transfer. Optionally, wavelength tunability is provided by changing the angle of inclination of the Fabry-Perot etalon relative to the laser source.

In the arrangement of U.S. Pat. No. 6,094,146, the light emitted by a laser diode is propagated towards an interference optical filter. Light passing through the filter and the light reflected therefrom are caused to impinge onto two photodiodes to generate respective output signals. The ratio of those signals is calculated in an arrangement including an adder, a subtractor and a divider. The arrangement further includes an error detector adapted to detect the difference between the output ratio and a reference value. The emission wavelength of the laser diode is controlled in such a way that the error signal may be equal to zero.

Somewhat similar arrangements are also known from U.S. Pat. No. 5,781,572, U.S. Pat. No. 6,384,947, EP-A-1 218 983 and JP07095159. Basically the same concepts are used in more recent solutions, as is the case of the Planar Lightwave Circuit (PLC) technology arrangement disclosed in WO-A-01/28052 in connection with multisection tunable lasers or of the more complex arrangement disclosed e.g. in U.S. Pat. No. 6,400,739, where light polarizers are used as beam splitters comprising a part of a co-integrated optical isolator.

A number of factors must be taken into account in applying such arrangements in order to produce compact stabilised optical sources.

Generating optical signals proportional to the optical power and wavelength of a laser source almost invariably requires the radiation from the laser source to be split over distinct propagation paths. In order to collect sufficient power, the light signal must be collimated into a low-divergence beam by using a lens. This arrangement necessitates a critical active alignment step, as recognised e.g. in K. Anderson, IEEE Electronic Component and Technology Conference, 1999, pp. 197-200. Additionally, the wavelength selective components must be temperature controlled in order to avoid drifts in the wavelength locking point generated by temperature changes. Also, the stabilization system must be adapted to be included in the same package of the laser source thus tackling the related problems in terms of optical coupling, space requirements (i.e. a small “footprint”) and power dissipation.

Most wavelength locking arrangements discussed in the foregoing are space consuming, difficult to optically align and/or difficult to manage, from the thermal point of view, due to their large passive load.

In EP patent application No. 03251480.4, an optical wavelength control system for an optical source is disclosed, including a beam splitter arrangement for propagating radiation from the source over two paths, first and second photodetectors each arranged in a respective one of the two propagation paths and a wavelength selective optical filter interposed in the propagation path from the source to the first photodetector. The first and second photodetectors are thus adapted to generate photocurrents indicative of the possible displacement of the actual wavelength of the radiation from the source with respect to a reference wavelength and the power emitted by the optical source, respectively. The arrangement also includes a support bench extending in a plane parallel to the laser diode emitting direction and the beamsplitter is positioned in order to split the radiation from the source towards the first and second photodetectors in a direction substantially perpendicular to the plane of the optical bench.

Additionally, GB patent application No. 0313544.9 discloses an optical component adapted for use in a wavelength locking arrangement. The arrangement disclosed in this document is based on the same concept underlying the EP document cited in the foregoing, namely splitting the main beam into a wavelength reference beam and an optical power reference beam. The component comprises a beam splitter and a prism with the orthogonal sides having semi-reflecting coatings acting as a Fabry-Perot etalon providing wavelength dependent optical transmittance and the optical radiation exiting the prism rotated substantially 90 degrees to the radiation entering the prism.

Despite the efforts witnessed by the prior art documents considered in the foregoing, the need is felt for arrangements that may lead to further improvements in terms of reduced space occupancy, reduced power dissipation, optimum optical couplings and simple optical alignment procedure.

The object of the present invention is to provide such a further improved solution.

According to the present invention, that object is achieved by means of an arrangement having the features set forth in the claims that follow, such claims being an integral part of the present disclosure. The invention also concerns a related method of assembly.

A preferred embodiment of the invention thus provides an optical wavelength control system for an optical source such as a laser diode, the system including:
a beam splitter arrangement for propagating radiation from said source over two paths,
first and second photodetectors, each arranged at a respective one of said two propagation paths,
a wavelength selective optical filter affecting propagation of said radiation over the propagation path to said first photodetector, whereby said first and second photodetectors are adapted to generate photocurrents indicative of the possible displacement of the actual wavelength of the radiation from said source with respect to a reference wavelength and the power emitted by said optical source, respectively; the wavelength selective optical filter is arranged to receive reflected radiation from the beam splitter arrangement.

Preferably, the wavelength selective optical filter and the first photodetector are arranged on opposite sides with respect to the propagation path of radiation from said source.

Still preferably, the wavelength selective filter is an interference filter or an etalon filter, and the beam splitter arrangement includes a first beam splitter to partly reflect radiation from the source towards the wavelength selective optical filter and to direct radiation reflected from the wavelength selective optical filter towards the first photodetector. The arrangement preferably includes a second beam splitter to at least partially reflect radiation from the source towards the second photodetector; the first beam splitter and the second beam splitter are reversely tilted at opposite inclination angles to the propagation path of radiation from the source in order to compensate the main beam displacement.

The arrangement described herein includes a frame, preferably of the heat conductive type, forming an assembly structure for the beam splitter arrangement, typically in the form of beam splitter plates, and the wavelength selective optical filter that is mounted on top of said frame. Additionally, a thermistor can be mounted on the frame.

The arrangement described herein includes a substrate for mounting the frame. The substrate is preferably a silicon optical bench having a raised portion for mounting the laser source and a lower portion for mounting the first and second photodetectors and the frame.

A preferred method of assembling an optical wavelength control system as described herein provides for the steps of assembling all the components before mounting the wavelength selective optical filter onto the frame as a final step. This assembly procedure permits to selectively adjust the mounting position of the optical filter in order to tune the locking wavelength at the right value.

The invention will now be described, by way of example only, with reference to the annexed figures of drawing, wherein:

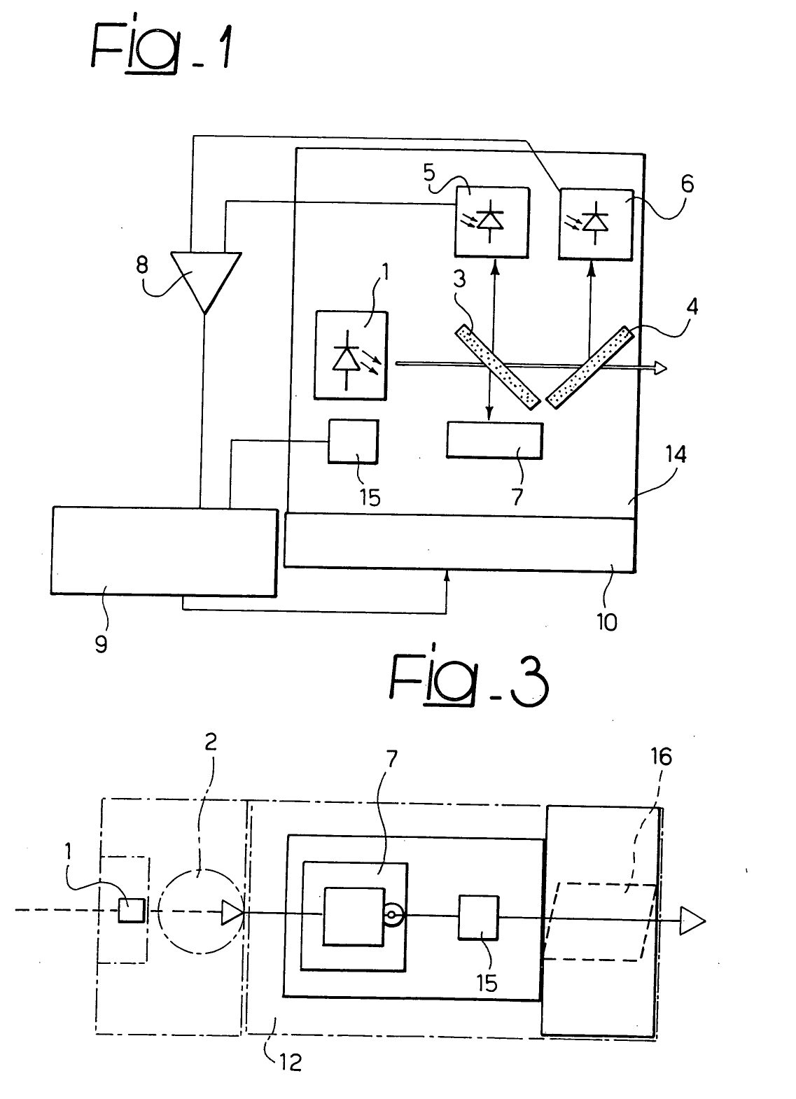

FIG. 1 is a schematic representation of the arrangement described herein,

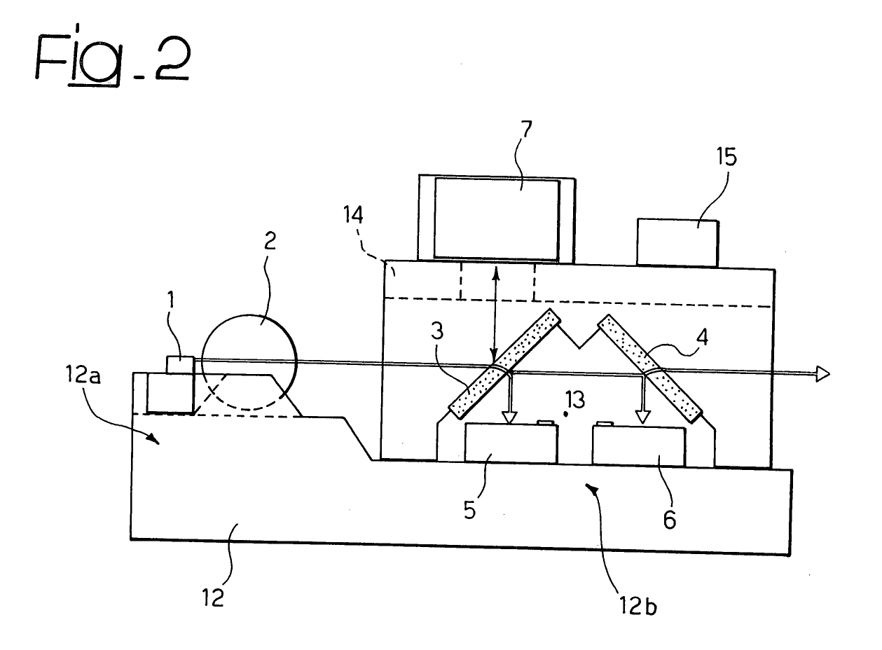

FIG. 2 is a longitudinal cross-sectional view of the practical embodiment of the arrangement described herein, and

FIG. 3 is a top plan view of the arrangement shown in FIG. 2.

The arrangement shown in the figures essentially corresponds to a transmitter for possible use in a transmitter optical sub-assembly (TOSA) dedicated to a device (e.g. an optical transceiver) used in optical communication systems such as e.g. a wavelength division multiplex (WDM) fiber optic communication system.

Essentially, the arrangement includes a laser source such as laser diode 1 having an associated lens 2 (such as a spherical or “ball” lens) to collimate the radiation emitted by the laser 1. The lens 2 is not shown in the schematic view of FIG. 1.

Associated with the laser 1 is an optical wavelength stabilising (“locking”) configuration consisting of a couple of partial (a few percent) reflectance beam splitters 3, 4, a couple of photodetectors 5, 6 and a wavelength filter 7. The beam splitters 3, 4 split the radiation emitted from the front facet of the laser source 1 and collimated by lens 2, generating two beams perpendicular to the direction of the main laser radiation beam. The two beams generated by the beam splitters 3 and 4 are sent towards two photodetectors, 5 and 6.

A wavelength selective optical filter 7 (positioned as better detailed in the following)
provides a wavelength dependent signal impinging on the first photodetector 5, while the second photodetector 6 receives a wavelength independent beam whose intensity is primarily dependent on the power emitted by the laser source 1.

By referring specifically to the schematic representation of FIG. 1, the output signals from the photodetectors 5 and 6 are pre-processed (signal conditioning, filtering, and so on) at a pre-processing unit 8 to be subsequently fed to a main signal processor 9 which is also adapted to drive a thermal conditioning unit 10 (typically a Peltier effect unit) adapted to selectively control the temperature of (the junction of) the laser diode 1 in order to stabilise the emission wavelength.

Additionally, the output signal from the photodetector 6 (representative of the optical power emitted by the laser source 1) can be separately used to activate an automatic power control function of the laser diode by regulating the bias current of the laser diode 1. This occurs via a laser bias current controller, of a known type.

Most of the foregoing corresponds to information that is well known in the art, thus making it unnecessary to provide a more detailed description herein. This applies primarily to the criteria adopted for exploiting the wavelength dependent signal output from the photodetector 5 and the power dependent signal output from the photodetector 6 to control the laser emission wavelength and power in order to “lock” them at the desired operation values.

A significant feature of the arrangement described herein lies in the fact that the wavelength locking arrangement described herein exploits the reflected filter signal produced by the combination of the beamsplitter 3 and the filter 7, in the place of the transmitted filtered signal, as commonly used in prior art arrangements.

Specifically, the first beam splitter 3 is arranged to partly reflect radiation from the source 1 towards the wavelength selective optical filter 7 and to direct radiation reflected from the wavelength selective optical filter 7 back towards the first photodetector 5.

The filter arrangement shown and described herein allows i.a. a symmetrical configuration with respect to the optical axis defined by the propagation path of radiation from the laser source 1. Specifically, the wavelength selective optical filter 7 and the first photodetector 5 are arranged on opposite sides with respect to the propagation path of radiation from the laser source 1.

Such an arrangement leads to a significant reduction in the dimensions of the whole device as better appreciated in connection with FIG. 3.

Turning now specifically to the detailed representation of FIG. 2, reference 12 designates a supporting element or substrate, which is preferably in the form of a so-called silicon optical bench (SiOB).

The SiOB 12 generally includes an elevated or raised portion 12a and a relatively lower/depressed portion 12b. The elevated or raised portion 12a is used for mounting the assembly comprised of the laser source 1 and the lens 2. The relatively lower/depressed portion 12b supports the photodiodes 5 and 6 and the assembly frame forming an enclosure for the beam splitter plates 3 and 4. The beam splitters 3 and 4 are arranged above the photodiodes 5 and 6 by means of the supporting structure (frame) comprised e.g. of a block 13 of a material that is essentially “open” (i.e. transparent) to the radiation emitted by the laser source 1.

In the preferred embodiment shown, the block 13 is approximately funnel- or roof-shaped, whereby the two beam splitter plates 3 and 4 have opposed inclinations with respect to the optical axis defined by the propagation path of radiation from the laser source 1. This arrangement leads to the beam splitter plates 3 and 4 being approximately perpendicular to each other.

Reference 14 generally designates a thermally conductive (e.g. metal) frame adapted to support the optical filter 7 plus, possibly, a thermally sensitive element 15 such as a thermistor included (in a manner known per se) in a control loop driven by the processor/driver unit 9 in order to ensure proper temperature conditioning of the whole assembly comprised of the laser diode 1, beam splitters 3 and 4, the photodetectors 5 and 6 and the optical filter 7.

Specifically, the heat conductive metal frame 14 carries the optical filter 7 properly oriented at a pre-set angle. This is typically an interference or etalon filter.

As indicated, the beam splitter plates 3 and 4 are reversely tilted (that is tilted at opposite angles to the propagation path of the radiation from the laser source 1) in order to avoid input-output beam displacement.

The two photodetectors 5 and 6 are usually mounted by conventional hybridization techniques on the substrate 12 together with the laser diode 1 and the lens 2.

This configuration leads to a very small occupancy and thermal load, together with an easier process of assembling the transmitter optical sub-assembly with respect to the previous solutions by using the bare minimum of components. Significantly, these are assembled without additional sub-mounts and the overall footprint is significantly reduced.

This permits to produce a very narrow TOSA in compliance with the most compact DWDM transceiver format such as the SFP (Small Form-factor Pluggable) format.

Just by way of example, the arrangement shown in FIG. 3 may have a width (vertical direction in the plane of the drawing) in the order of 2 mm, while the wavelength locker portion proper (excluding the laser source 1 and the lens 2, but including an optical isolator 16 usually associated with the output of the wavelength locking arrangement) may have an overall length in the order of 3.5 mm.

Of course, these data are purely exemplary and, as such, are in no way limiting of the scope and nature of the invention.

An additional advantage related to the arrangement described herein comes from the possibility of completing the electrical assembly of the TOSA before fixing the filter 7 as a final step.

In fact, the frame 14 forms an assembly unit for the beam splitter arrangement 3, 4 to be aligned to the photodetectors 5, 6 while the wavelength selective optical filter 7 is mounted on top of the frame 14. The possibility thus exists of slightly tilting the filter 7 during the mounting phase in order to actively adjust the filter position such as to “tune” the wavelength control action exactly at the operating conditions of temperature and power supply. This can be done by applying the right electrical signals on the external connections of the TOSA and looking at the optical output while the filter position is adjusted.

All the optical components included in the arrangement shown can thus be conveniently mounted on a small silicon optical bench substrate 12 with good thermal and mechanical performance. Such a silicon crystal substrate can be produced by micromachining with a very high degree of precision. Additionally, using such a substrate 12 is particularly convenient for mass production processes as using such substrate 12 simplifies mounting of the optical components by means of passive aligning processes, thus reducing the cost associated with assembly of the TOSA.

Without prejudice to the underlying principles of the invention, the embodiments and details may vary, also significantly, with respect to what has been described by way of example only, without departing from the scope of the invention as defined by the claims that follow. Specifically, those of skill in the art will appreciate that terms such as “optical”, “light”, “photodetector”, and the like are evidently used herein with the meaning currently allotted to those terms in fiber and integrated optics, being thus intended to apply i.e. to radiation including the infrared, visible and ultraviolet ranges.

1. An optical wavelength control system for an optical source, the system including:
a beam splitter arrangement for propagating radiation from said source over two paths,
first and second photodetectors, each arranged at a respective one of said two propagation paths,
a wavelength selective optical filter affecting propagation of said radiation over the propagation path to said first photodetector, whereby said first and second photodetectors are adapted to generate photocurrents indicative of the possible displacement of the actual wavelength of the radiation from said source with respect to a reference wavelength and the power emitted by said optical source, respectively,
wherein said wavelength selective optical filter is arranged to receive reflected radiation from said beam splitter arrangement.

2. The system of claim 1, wherein said wavelength selective optical filter is an interference filter.

3. The system of claim 1, wherein said wavelength selective optical filter is an etalon filter.

4. The system of claim 1, wherein said wavelength selective optical filter and said first photodetector are arranged on opposite sides with respect to the propagation path of radiation from said source.

5. The system of claim 1, wherein said beam splitter arrangement includes a first beam splitter arranged to partly reflect radiation from said source towards said wavelength selective optical filter and to direct radiation reflected from said wavelength selective optical filter towards said first photodetector.

6. The system of claim 5, wherein said beam splitter arrangement includes a second beam splitter to at least partially reflect radiation from said source towards said second photodetector.

7. The system of claim 6, wherein said first beam splitter said second beam splitter are reversely tilted at opposite inclination angles to the propagation path of radiation from said source.

8. The system of claim 6, wherein said first and second beam splitters are in the form of beam splitter plates.

9. The system of claim 1, including an assembly frame for said beam splitter arrangement, wherein said wavelength selective optical filter is mounted on said frame.

10. The system of claim 9, wherein said frame is a thermally conductive frame.

11. The system of claim 9, wherein said frame also supports a heat-sensitive element for the thermal conditioning of the optical wavelength control system.

12. The system of claim 1, including a substrate for mounting said beam splitter arrangement, said first and second photodetectors and said wavelength selective optical filter.

13. The system of claim 12, wherein said substrate is a silicon optical bench (SiOB).

14. The system of claim 12, including a common substrate having a raised portion for mounting said laser source and a lowered portion for mounting said first and second photodetectors.

15. The system of claim 1, including a lens to focus radiation from said source.

16. The system of claim 15, wherein said lens is a spherical lens.

17. A method of assembling an optical wavelength control system according to claim 1, comprising:
assembling the optical wavelength control system but for said wavelength selective optical filter, and
mounting said wavelength selective optical filter onto said optical wavelength control system as a final step in assembling the system by selectively adjusting the mounting position of said wavelength selective optical filter.

18. The method of claim 17, wherein mounting said wavelength selective optical filter includes the operation of actively positioning said wavelength selective optical filter such as to exactly match the locking wavelength at the operating conditions.
